(19) United States
(12) Patent Application Publication
(10) Pub. No.: US 2022/0308660 A1
(43) Pub. Date: Sep. 29, 2022

(54) AUGMENTED REALITY BASED CONTROLS FOR INTELLIGENT VIRTUAL ASSISTANTS

(71) Applicant: International Business Machines Corporation, Armonk, NY (US)

(72) Inventors: Subha Kiran Patnaikuni, Visakhapatnam (IN); Sarbajit K. Rakshit, Kolkata (IN)

(21) Appl. No.: 17/211,963

(22) Filed: Mar. 25, 2021

(51) Int. Cl. G06F 3/01; H04L 29/08; G06F 3/16; G06F 3/14; G10L 15/08; G10L 15/22; G02B 27/01

(52) U.S. Cl. CPC G06F 3/013; H04L 67/12; G06F 3/017; G06F 3/165; G06F 3/14; G10L 15/08; G10L 15/22; G06F 3/167; G02B 27/0172; G02B 27/0179; G10L 2015/088; G10L 2015/223; G02B 2027/0138; G02B 2027/0187; G02B 2027/0178

(57) ABSTRACT

Disclosed are techniques for augmented reality (AR) interfaces with voice activated devices for providing intelligent virtual assistant functions, sometimes referred to as smart speakers. A smart speaker is paired to an AR device. Volume threshold indicators are displayed on an AR display of the AR device, which can be interacted with through gesture based input to control volume thresholds for the smart speaker to detect and recognize voice commands. When the smart speaker receives wakeup commands, the AR device displays interface elements corresponding to time remaining to provide a voice command to the intelligent virtual assistant through the smart speaker. The time remaining to provide a voice command can be modified by gesture based inputs detected by the AR device.

### BACKGROUND

The present invention relates generally to the field of augmented reality interfaces, and more particularly to managing wakeup status parameters for intelligent virtual assistant devices through augmented reality interfaces.

Augmented reality (AR) systems refer to interactive experiences with a real-world environment where objects which reside in the real world are modified by computer-generated perceptual information, sometimes across two or more sensory modalities, including visual, auditory, haptic, somatosensory and olfactory. AR systems are frequently defined to require three basic features: a combination of real and virtual worlds, real-time interaction, and accurate 3D registration of virtual and real objects. The overlaid sensory information typically comes in two varieties. The first variety is constructive (i.e. additive to the natural environment), and the second variety is destructive (i.e. masking of the natural environment). This experience is smoothly interwoven with the physical world in such a way that it is frequently perceived as an immersive aspect of the real environment. In this way, AR alters a person's ongoing perception of a real-world environment, as contrasted to virtual reality which fully replaces the user's real-world environment with a simulated one. AR is related to two terms which are largely synonymous: mixed reality and computer-mediated reality. With the help of advanced AR technologies (e.g. incorporating computer vision, leveraging AR cameras into smartphone applications and object recognition) information about the surrounding real world of the AR user becomes interactive and digitally manipulated. Information about the environment and objects within it is overlaid onto the real world.

A head-mounted display (HMD) is a display device worn on the head or as part of a helmet with a small display optic positioned for viewing by one eye (in the instance of monocular HMDs) or each eye (in the instance of binocular HMDs). Augmented Reality devices and Virtual Reality devices are types of head mounted displays.

User interfaces (UI) of AR devices often include projecting digital content and interactive elements into the field of view of the user. The user interacts with the digital content and interactive elements through speech recognition systems that convert a user's spoken words into computer instructions, gesture recognition systems that translate a user's body movements through either visual detection via cameras or from sensors embedded in a peripheral device such as a wand, stylus, pointer, glove or other body wear.

Eye tracking describes the process of measuring either the point of gaze (where someone is looking) or the motion of an eye relative to the head. An eye tracker is a type of device for measuring eye positions and eye movements. One of the most broadly used current designs are video-based eye-trackers. In a video-based eye tracker, a camera focuses on one or both eyes and records eye movement as the viewer observes some type of stimulus. Many modern eye-trackers use the center of the pupil and infrared/near-infrared non-collimated light to create corneal reflections (CR). The vector between the pupil center and the corneal reflections is used to calculate either the point of regard on surface or the gaze direction. A simple calibration procedure of the individual is typically required before using the eye tracker.

The Internet of things (IoT) is a system of interrelated computing devices, mechanical and digital machines provided with unique identifiers (UIDs) and the capability to transfer information over a network without requiring human-to-human or human-to-computer interaction. The definition of the Internet of things has evolved over time due to the convergence of multiple technologies such as real-time analytics, commodity sensors, machine learning, and embedded systems. Traditional fields of embedded systems such as wireless sensor networks, control systems, automation (including home and building automation), and others all contribute to facilitating the Internet of things.

An intelligent virtual assistant (IVA) or intelligent personal assistant (IPA), also sometimes referred to as an AI voice assistance system, is a software agent that can perform tasks or services for an individual based on commands or questions. Some virtual assistants are able to interpret human speech and respond via synthesized voices. Users can present questions to their assistants, control home automation devices and media playback, and manage other basic tasks such as email, to-do lists, and calendars through the use of voice commands.

A smart speaker is a type of speaker and voice command device with an integrated intelligent virtual assistant that offers interactive actions and hands-free activation with the help of one “hot word” (sometimes “hot words”). A hotword may also be known as an activation word or wake command, which “activates” or “awakens” the intelligent virtual assistant interfacing through the smart speaker. Some smart speakers may also act as a smart device which leverages Wi-Fi, Bluetooth and other protocol standards to extend usage beyond audio playback, such as to control home automation devices or IoT devices. Some IoT devices include capabilities to detect and relay input for a smart speaker or intelligent virtual assistant, and provide some types of outputs in reply. Each can have its own designated interface and features in-house, usually launched or controlled via application or home automation software. Smartglasses, sometimes called smart glasses or AR glasses, are wearable computer glasses that add information alongside or to what the wearer sees.

### SUMMARY

According to an aspect of the present invention, there is a method, computer program product and/or system for use with an augmented reality (AR) device that performs the following operations (not necessarily in the following order): (i) pairing the AR device with at least one AI voice assistance device(s) over a computer network; and (ii) responsive to the at least one AI voice assistance device recognizing a wakeup command, displaying, on a display of the AR device, a visual element indicative of time remaining for the at least one AI voice assistance device(s) to remain in an awakened state after recognizing the wakeup command.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4A is a screenshot view of an interface generated by the first embodiment system;

FIG. 4B is a screenshot view of an interface generated by the first embodiment system;

FIG. 5A is a screenshot view of an interface generated by the first embodiment system;

FIG. 5B is a screenshot view of an interface generated by the first embodiment system; and

FIG. 6 is a screenshot view of an interface generated by a second embodiment.

### DETAILED DESCRIPTION

Some embodiments of the present invention are directed to techniques for augmented reality (AR) interfaces with voice activated devices for providing intelligent virtual assistant functions, sometimes referred to as smart speakers. A smart speaker is paired to an AR device. Volume threshold indicators are displayed on an AR display of the AR device, which can be interacted with through gesture based input to control volume thresholds for the smart speaker to detect and recognize voice commands. When the smart speaker receives wakeup commands, the AR device displays interface elements corresponding to time remaining to provide a voice command to the intelligent virtual assistant through the smart speaker. The time remaining to provide a voice command can be modified by gesture based inputs detected by the AR device.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium sometimes referred to as a machine readable storage device, can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be any thing made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

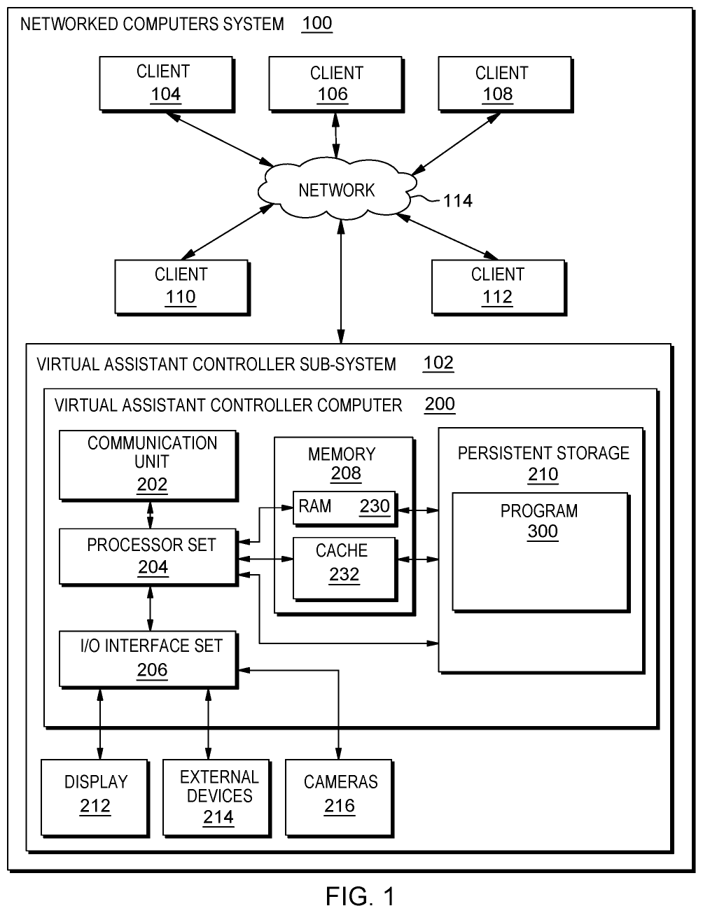

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device(s) 214. External device(s) 214 will typically include devices such as a keyboard, keypad, a touch screen, and/or some other suitable input device. External device(s) 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen, or an AR display. Camera(s) 216 is an array of optical sensors that enable eye tracking of a user wearing virtual assistant controller sub-system 102 and also computer vision/object recognition of objects and entities observed from the perspective of the user wearing virtual assistant controller sub-system 102.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

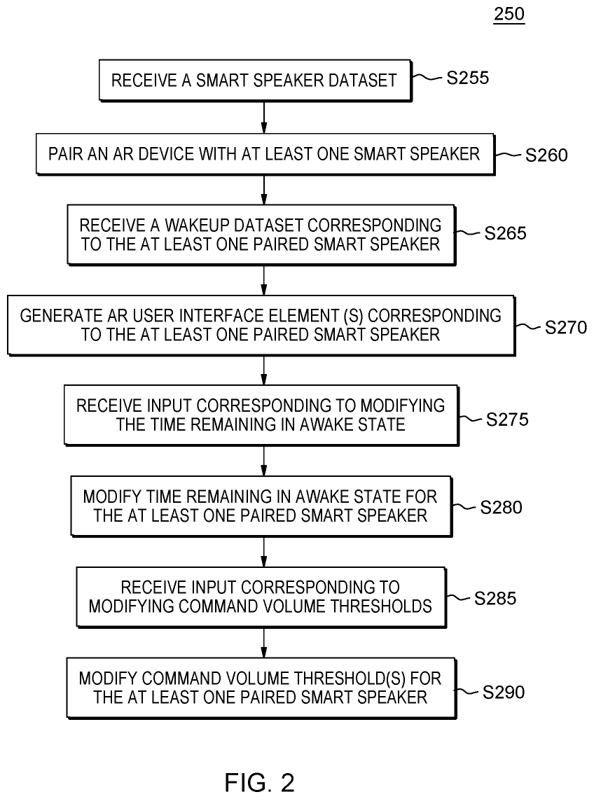

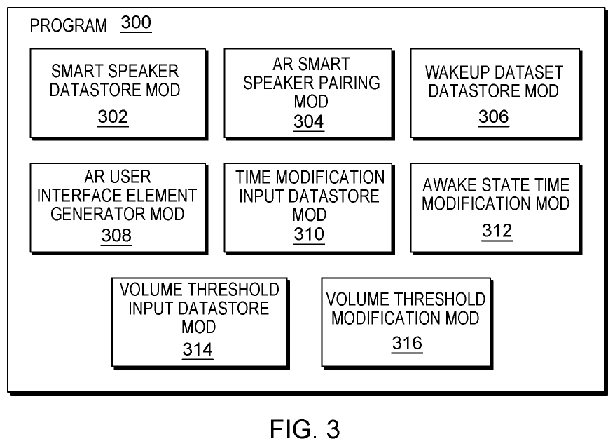

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2, 3, 4A-4B and 5A-5B.

Processing begins at operation S255, where smart speaker datastore module (“mod”) 302 receives a smart speaker dataset. In this simplified embodiment, the smart speaker dataset includes identity information for a smart speaker device connected to a wireless computer network and a set of parameter values for minimum voice volume thresholds for recognizing a voice command. The identity information, in this instance, includes the following: (i) type of smart speaker device—an ExampleCorp Smart Speaker; (ii) name of smart speaker device—Kitchen Smart Speaker; and (iii) IoT communication protocol—ExampleProtocol. Also in this simplified embodiment, the set of parameter values for minimum voice volume thresholds for recognizing a voice commands (or voice command threshold(s) includes the following information: (i) 60 decibels, or 60 dB.

Note, this simplified embodiment refers to a “smart speaker” device for descriptive purposes; alternative embodiments may supplement or substitute the “smart speaker” of the simplified embodiment with additional smart speaker devices, or other devices with intelligent virtual assistant capabilities, including, but not limited to: (i) receiving wakeup words for waking the intelligent virtual assistant; (ii) receiving voice commands for the intelligent virtual assistant; and (iii) outputting results or confirmation voice commands received by the intelligent virtual assistant. In some alternative embodiments, other types of identity information may comprise the identity information dataset, including network IDs, MAC addresses, device model numbers, device serial numbers, passwords/access keys, or other types of information known by a person of ordinary skill in the art for identifying an IoT device within a wireless computer network. In some further alternative embodiments, the set of parameter values for minimum voice volume thresholds includes other parameters or values for sound volume thresholds.

Processing proceeds to operation S260, where AR smart speaker pairing mod 304 pairs an AR device with at least one smart speaker. In this simplified embodiment, the AR device is a set of AR eyeglasses (also referred to as AR glasses) that provide an augmented reality overlay in the field of view of a user wearing the AR glasses, as well as cameras and sensors that observe objects and entities present in the field of view of the user wearing the AR glasses, such as detecting the presence of smart speaker. Pairing includes establishing a data connection over a wireless computer network (such as WiFi, Bluetooth, etc.) that provides bidirectional flow of data, such as status information sent from the smart speaker to the AR glasses, or parameter adjustments sent from the AR glasses to the smart speaker. In this simplified embodiment, the AR glasses are paired with the Kitchen Smart Speaker identified in the smart speaker dataset stored in smart speaker datastore mod 302. In some alternative embodiments, multiple smart speakers are paired with the AR device simultaneously, such as in a household with a plurality of devices with intelligent virtual assistant capabilities, and AR smart speaker pairing mod 304 pairs with each separate smart speaker such that the AR device may send and receive data with each smart speaker device over the computer network.

Processing proceeds to operation S265, where wakeup dataset datastore mod 306 receives a wakeup dataset corresponding to the at least one paired smart speaker. In this simplified embodiment, the Kitchen Smart Speaker has a wakeup command word of “Alfred,” which when spoken, changes the status of the Kitchen Smart Speaker to “awake.” When the Kitchen Smart Speaker is in the “awake” state, it begins to listen for a subsequent command spoken verbally by a user. A user wearing the AR glasses speaks the word “Alfred,” which is received by the Kitchen Smart Speaker with a volume of 65 dB. This causes the Kitchen Smart Speaker to enter the awake state and send the wakeup dataset. In this simplified embodiment, the wakeup dataset includes the following information: (i) awake state=true; (ii) duration of awake state=10 seconds. In some alternative embodiments, where more than one smart speaker is paired with the AR device, the wakeup dataset may include data corresponding to more than one smart speaker, such as when two or more smart speakers are in simultaneous (or alternatively, overlapping) awake states in response to a single (or alternatively, plural) utterances of a shared (or alternatively, different) wakeup command words. In yet further alternative embodiments, the wakeup dataset may include information known to a person of ordinary skill in the art that concerns a smart speaker device or intelligent virtual assistant entering an awake state.

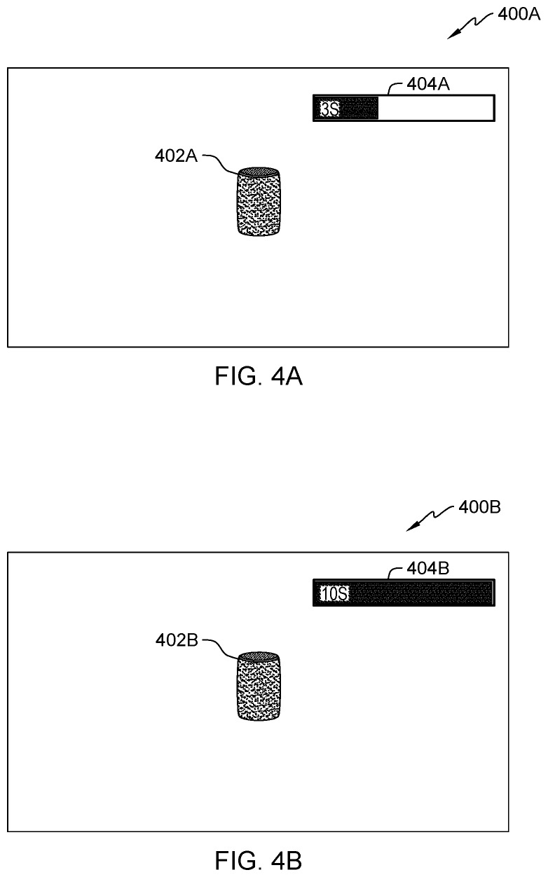

Processing proceeds to operation S270, where AR user interface element generator mod 308 generates AR user interface element(s) corresponding to the at least one paired smart speaker. In this simplified embodiment, the AR user interface element(s) is a progress bar showing how much time remains to input a voice command to the Kitchen Smart Speaker when it is in the awake state, which includes an outline showing how much time was available according to the duration of awake state received in the wakeup dataset. As this is an AR user interface element(s), it is displayed as an overlay over the user's view of their surroundings from the perspective of their eyes, and includes a line tracing the progress bar to the Kitchen Smart Speaker (as viewed from the perspective of the eyes of the user). The progress bar will change depending on how many seconds have elapsed since the Kitchen Smart Speaker received the wakeup command word. For example, screenshot 400A of FIG. 4A shows progress bar 402A as would be viewed by the user 7 seconds after the Kitchen Smart Speaker recognizes that the user has uttered “Alfred” at a volume of at least 60 dB. As shown in FIG. 4A, there are only 3 seconds remaining to input a voice command while the Kitchen Smart Speaker remains in the awake state after the user previously uttered “Alfred.” However, if the user was observing the progress bar immediately after the Kitchen Smart Speaker recognized the user's utterance of “Alfred” with a volume of at least 60 dB, it would appear as in progress bar 404B shown in screenshot 400B of FIG. 4B, shown near Kitchen Smart Speaker 402B. The progress bar is a type of timer showing how much time remains.

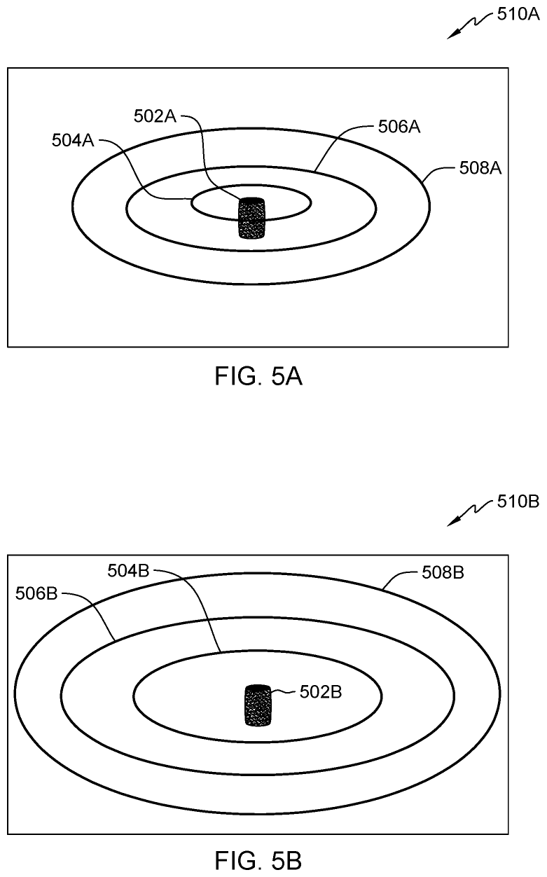

Additionally, the AR user interface element(s) includes three concentric rings, centered on the Kitchen Smart Speaker along a plane parallel to the ground, where each ring corresponds to a different threshold for how loud a person must utter a command word that will be recognized by the Kitchen Smart Speaker as a valid command word. An example of this is shown in screenshot 510A of FIG. 5A, where Kitchen Smart Speaker 502A is surrounded by a first ring 504A corresponding to a quiet volume threshold of 40 dB, a second concentric ring 506A corresponding to a normal conversation volume threshold of 60 dB, and a third concentric ring 508A corresponding to a loud conversation volume threshold of 75 dB. In some alternative embodiments, cameras 216 on the AR glasses are used to detect if the Kitchen Smart Speaker is visible from the perspective of the user wearing the AR glasses.

In some alternative embodiments, other types of AR user interface element(s) can be shown including: (i) numbers indicating remaining time; (ii) a color coded progress bar where changes in color of the progress bar indicate remaining time (such as red suggesting more urgency and green or blue suggesting low or minimal urgency, and other colors in-between such as yellow and orange suggesting degrees of urgency between the above); (iii) clock faces indicating remaining time; and (iv) an hourglass indicating remaining time. Other types of interface elements known by those skilled in the art may also be used in alternative embodiments. In alternative embodiments with a plurality of smart speakers paired to the AR device, AR user interface element(s) are generated (and displayed upon display 212 of FIG. 1) corresponding to each smart speaker presently in the awake state. Where such smart speakers differ on their duration of awake state (and similarly, remaining time to input a voice command), AR user interface element(s) for the smart speakers will independently reflect the correct times for each smart speaker.

Processing proceeds to operation 5275, where time modification input datastore mod 310 receives input corresponding to modifying the time remaining in awake state. In this simplified embodiment, 7 seconds have elapsed since the Kitchen Smart Speaker recognized that the user uttered “Alfred” at a volume of 66 dB. Also in this simplified embodiment, the input corresponding to modifying the time remaining in awake state (hereafter referred to as the “time input”) includes the following components: (i) gesture input; and (ii) eye tracking input. First, the eye tracking input includes camera(s) 216 of FIG. 1 detecting that the user's gaze has settled on the Kitchen Smart Speaker and then traveled to progress bar 404A of FIG. 4A, as shown on display 212 of FIG. 1. This indicates “selection” of progress bar 404A of FIG. 4A. The gesture input includes camera(s) 216 of FIG. 1 observing the user raising their pinched index finger and thumb behind progress bar 404A of FIG. 4A and extending their index finger and thumb apart in a type of gesture similar to a reverse pinching motion to extend the length of progress bar 404A.

In some alternative embodiments, the time input includes one or both types of the above components, using different input values known by those of ordinary skill in the art (such as different gestures or different eye tracking values). In further alternative embodiments, other types of input corresponding to other types of interactions with the time remaining in the awake state for the Kitchen Smart Speaker are received, concerning interactions such as: (i) pausing the progression of time for the time remaining in the awake state for the Kitchen Smart Speaker; and (ii) resuming the progression of time for the time remaining in the awake state for the Kitchen Smart Speaker. One example gesture for such interactions includes the user extending a finger towards where the AR user interface element(s) appear within their vision and “double tapping” their finger on the AR user interface element(s) to affect a pause or resume interaction. An alternative gesture the user “snapping” their fingers within their field of view. In some alternative embodiments, the AR device, such as a pair of AR glasses, includes retinal sensors for

Processing proceeds to operation S280, where awake state time modification mod 312 modifies time remaining in awake state for the at least one paired smart speaker. In this simplified embodiment, based on the time input received at S275, awake state time modification mod 312 modifies time remaining in awake state for the Kitchen Smart Speaker to remain in the present awake state. Awake state time modification mod 312 uses the following data points to modify the remaining time in the current awake state for the Kitchen Smart Speaker: (i) current time remaining in the current awake state for the Kitchen Smart Speaker (which correlates to the size of progress bar 404A of FIG. 4A); (ii) distance between the index finger and thumb of the user observed during the reverse pinching gesture of the time input. In an example of how these data points are used, the greater the extension of the user's thumb and fingers apart relative to the size of progress bar 404A, the greater the amount of time appended to the time remaining in the current awake state for the Kitchen Smart Speaker, with smaller movements affecting a smaller modification to the time remaining in the current awake state for the Kitchen Smart Speaker. Sufficiently large extensions may result in more time remaining in the current awake state for the Kitchen Smart Speaker than the original duration indicated in the wakeup dataset. In some alternative embodiments, such extensions (referring to “sufficiently large extensions”) results in a modification to the duration value indicated in the wakeup dataset such that subsequent wakeup commands received by the Kitchen Smart Speaker begin with the now increased duration. Referring back to the present simplified embodiment, the time input includes gesture information corresponding to modifying the time remaining in the current awake state for the Kitchen Smart Speaker to be 10 seconds, which is reflected in the AR user interface element(s) viewed by the user on display 212 of FIG. 1, as shown by progress bar 404B of FIG. 4B.

Processing proceeds to operation S285, where volume threshold input datastore mod 314 receives input corresponding to modifying command volume thresholds. In this simplified embodiment, a command volume threshold is the minimum volume threshold required for a smart speaker to recognize a voice command (including a wakeup command, such as “Alfred”) via the microphone(s) of the smart speaker. It is possible for the microphone(s) of the smart speaker to detect noises beneath the command volume threshold, but the command volume threshold determines the minimum volume required for a noise to be analyzed for matching a valid voice command (such as the wakeup command “Alfred”). A lower voice command volume threshold would enable the smart speaker to recognize voice commands at quieter volumes, such as when a user desires to interact with the smart speaker while providing minimal disturbance to other entities in the surroundings. Likewise a higher voice command volume threshold would require the user to utter voice commands at a louder volume in order for the smart speaker to recognize the utterance as a valid voice command (instead of ignoring the utterance), which may be advantageous during events where the ambient volume is loud (such as while watching loud programming from a nearby multimedia device, or during a party or gathering), mitigating utterances resulting in unintended recognition as a voice command by the smart speaker.

Also, in this simplified embodiment, the input corresponding to modifying command volume thresholds (hereafter referred to as the “volume input”) includes the following components: (i) gesture input; and (ii) eye tracking input. First, the eye tracking input includes camera(s) 216 of FIG. 1 detecting that the user's gaze has settled on the Kitchen Smart Speaker. This indicates “selection” of the Kitchen Smart Speaker. Concerning the gesture input, a first gesture sub-component is received (after the eye tracking component is received) indicating a volume threshold changing interaction. In this simplified embodiment, the volume threshold changing gesture is two extended index fingers, separated by some observable distance, extended upright and appearing between the user and the Kitchen Smart Speaker (from the perspective of the user, as observed by camera(s) 216 of FIG. 1). A second gesture sub-component includes either expanding or retracting the distance between the two extended, upright index fingers. In this simplified embodiment, the second gesture sub-component corresponds to expanding (or increasing) the distance between the two index fingers. In some alternative embodiments, the volume input includes one or both types of the above components, using different input values known by those of ordinary skill in the art (such as different gestures or different eye tracking values).

Processing proceeds to operation S290, where volume modification threshold mod 316 modifies command volume threshold(s) for the at least one paired smart speaker. In this simplified embodiment, based on the volume input, volume modification threshold mod 316 modifies command volume threshold(s) for the Kitchen Smart Speaker. For this simplified embodiment, the second gesture sub-component, which corresponds to expanding (or increasing) the distance between the two index fingers, is interpreted by volume modification threshold mod 316 to modify the command volume threshold(s) of the Kitchen Smart Speaker by decreasing the command volume threshold(s). The degree of extension (or retraction) is translated by volume modification threshold mod 316 into different values for modifying the command volume threshold(s) of the Kitchen Smart Speaker, with extensions (or retractions) from the original positions of the index fingers corresponding to proportional changes to the command volume threshold(s). As discussed further above, lowered command volume threshold(s) enable Kitchen Smart Speaker to recognize voice commands at quieter volumes. In this simplified embodiment, the second gesture sub-component corresponds to a reduction of the command volume threshold(s) from 60 dB to 40 dB.

This is reflected in the AR user interface element(s) shown to the user via display 212 of FIG. 1, as illustrated in screenshot 510B of FIG. 5B, where Kitchen Smart Speaker 502B shows reduced command volume threshold(s) via the increased radii of first concentric circle 504B, second concentric circle 506B, and third concentric circle 508B (relative to their respective counterparts in FIG. 5A). The concentric rings shown in FIGS. 5A and 5B provide visual cues to the user within their environment for minimum vocal volume levels to submit voice commands that will be recognized by the Kitchen Smart Speaker. As the command volume threshold(s) for the Kitchen Smart Speaker have been lowered (meaning a quieter voice command will still be recognized), the rings have increased radii in FIG. 5B relative to the rings in FIG. 5A, where FIG. 5A illustrates the AR user interface element(s) of the Kitchen Smart Speaker prior to the modification at S290.

In some alternative embodiments, while the user is actively providing the volume input, volume modification threshold mod 316 continuously modifies command volume threshold(s) for the Kitchen Smart Speaker and proportionally modifies the concentric rings of the AR user interface element(s) that correspond to the command volume threshold(s) of the Kitchen Smart Speaker. In further alternative embodiments, after the command volume threshold(s) have been modified in such a way as in S290, the user (or another user) submits a voice command of “lights off,” corresponding to a voice command to the intelligent virtual assistant to turn off any IoT connected lights designated as corresponding to the room “the kitchen,” with a voice volume of 41 dB for the “lights off” command. In some alternative embodiments, other types of voice commands are submitted to Kitchen Smart Speaker (and correspondingly, to the intelligent virtual assistant) such as any voice commands known by a person of ordinary skill in the art.

### III. Further Comments and/or Embodiments

Some embodiments of the present invention recognize the following facts, potential problems and/or potential areas for improvement with respect to the current state of the art: (i) while submitting any voice command to any AI voice assistance system (for example Amazon Alexa®, Google Home® etc.) a wakeup command is submitted to enable the AI voice assistance system to listen to any voice commands uttered by one or more users; (ii) a wakeup command can be a specific spoken keyword, or any IoT based signals from surrounding devices; (iii) after submitting any wakeup command, if the user does not submit a voice command within a predefined time range, the AI voice assistance will return to a sleep mode; (iv) the user has to again submit a wakeup command before submitting a voice command; (v) while submitting any wakeup command, a user may not be able to understand the wakeup duration; (vi) the user might be delayed from submitting the voice command; (vii) or the user might move out of the reception range of the AI voice assistance system; (viii) there exists a need for techniques by which users can visualize the remaining time for wakeup commands; and (ix) or can also control the wakeup command parameters while interacting with the AI voice assistance system.

Some embodiments of the present invention may include one, or more, of the following operations, features, characteristics and/or advantages: (i) a user can use a head mounted augmented reality glass to visualize the remaining time for a wakeup command duration; (ii) user can also selectively control the wakeup command (such as pausing, resuming or extending the wakeup command duration); (iii) control the boundary range of a given AI voice assistance device; (iv) selectively define the people who can submit the voice command within the defined wakeup range; (v) control the wakeup command parameters while interacting with AI voice assistance system; (vi) the wakeup parameters can be (a) duration of wakeup, (b) pausing, (c) resuming the wakeup, (d) controlling the boundary of wakeup range, etc.; (vii) this will have better control of wakeup commands corresponding to the AI voice assistance system; and (viii) the user's interaction with AI voice assistance system will be more interactive as a result.

Some embodiments of the present invention may include one, or more, of the following operations, features, characteristics and/or advantages: (i) after submitting any wakeup command to an AI voice assistance system, a user can use a head mounted augmented reality glass device to visualize a “wakeup duration” progress bar; (ii) accordingly, the user can understand the remaining time that the AI voice assistance will remain be awake to receive a subsequent voice command and execute said voice command; (iii) using augmented reality glass the user can interact with a progress bar corresponding to the “wakeup duration” of any AI voice assistance system; (iv) while interacting with the progress bar, the user can increase the wakeup duration in the progress bar; (v) other interactions include (a) pause, (b) resume, and (c) stopping the wakeup of any AI voice assistance system currently within the “wakeup duration”; (vi) in any surrounding, there can be multiple voice assistance devices (for example, (a) TV, (b) washing machine, etc.) apart from a hub or central AI voice assistance system; (vii) each of the devices can be switched to an awake status based on device specific wakeup calls; (viii) if multiple wakeup commands are submitted to multiple devices, the AR glass will individually show the “wakeup duration” progress bar for each of the wakeup commands; (ix) if multiple wakeup commands are submitted for same AI voice assistance system or any voice enabled device, then AR device will be showing the overlap “wakeup duration” progress bar assigned to different people who have individually submitted voice commands; (x) accordingly can selectively interact with the “wakeup duration” progress bar individually; (xi) using hand or eye gestures, the user can interact with the “wakeup duration” progress bar in any surroundings; (xii) or if multiple “wakeup duration” progress bar are showing at simultaneously, the user's eye focus distance can select the appropriate “wakeup duration” progress bar and can control it; (xiii) using AR glass, the user can also visualize the physical boundary around any device where wakeup command will be activated based on any given loudness factor of voice command; (xiv) the user can visualize the level of loudness based wakeup boundary ranges of any AI voice assistance device; (xv) this visual diagram will help the user to understand what will be the required loudness of his voice command based on the distance from the AI voice assistance system; (xvi) or user can decide if the user can move closer to the device to submit the voice command; (xvii) based on historical interaction with “wakeup duration” progress bar in different contextual situations, like when the user is expanding the wakeup duration, when the user pausing, resuming etc., and accordingly based on historical data, machine learning is performed to understand the user's interaction with “wakeup duration” progress bar; and (xviii) this will help the proposed system to perform auto execution of “wakeup duration” progress bar interaction.

Some embodiments of the present invention may include one, or more, of the following operations, features, characteristics and/or advantages: (i) in any surroundings there can be multiple voice controlled devices (like multiple TVs, Microwave oven) apart from AI voice assistance system (like Amazon Alexa) etc.; (ii) each of the voice controlled devices, or AI voice assistance systems, have individual voice commands, and the devices are awakened individually when respective wakeup commands are submitted; (iii) an augmented reality device of the user is paired with each and every voice controlled device and also AI voice assistance systems in the surrounding; (iv) when any wakeup command is submitted, the voice assistance system will recognize the voice and identify the users who have submitted the voice command; (v) when any wakeup command is submitted, the AR device will gather information from the respective devices which are awakened; (vi) AR device shows the wakeup status of the various voice controlled devices; (vii) the wakeup duration is preconfigured in any voice assistance or voice enabled device; (viii) if the device does not accept any voice command during the awake timeline, then the device will again go to sleep and needs a fresh wakeup call before receiving voice command; (ix) the AI voice assistance system(s), and voice enabled devices will be sharing the wakeup duration configuration of head mounted AR glass; (x) the AI voice assistance system and also the voice assistance system has a configuration on loudness factor of the voice command; (xi) if the loudness is less than the threshold limit then the voice command will not be executed; (xii) the AR glass will also identify the timeline when any voice command is submitted; (xiii) based on a preconfigured wakeup duration, it will know how much time is elapsed and how much time is remaining; (xiv) the AR glass will create a progress bar to show the wakeup duration of the AI voice assistance system; and (xv) multiple simultaneous (or overlapping) wakeup commands can be submitted to multiple devices, or to the same device by different persons.

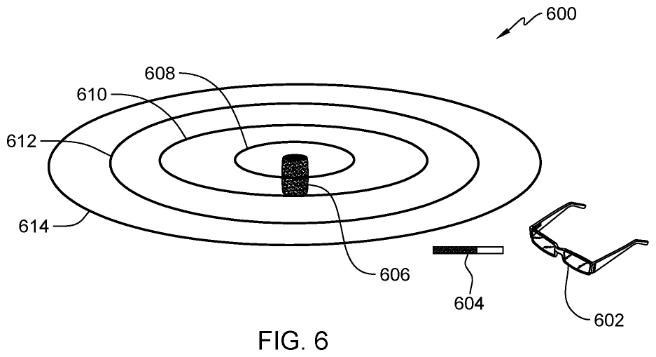

As shown in FIG. 6, diagram 600 includes the following elements: (i) AR glasses 602; (ii) AI voice assistance device wakeup duration progress bar 604; (iii) AI voice assistance device 606; (iv) visual whisper loudness/distance boundary indicator 608; (v) visual low voice loudness/distance boundary indicator 610; (vi) visual normal conversation loudness/distance boundary indicator 612; and (vii) visual loud voice loudness/distance boundary indicator 614. Each visual loudness/distance boundary indicator corresponds to a graphical interface element shown on AR glasses 602 showing different distances from AI voice assistance device 606 where AI voice assistance device 606 will recognize voice commands and their respective speaking volumes. For example, visual whisper loudness/distance boundary indicator 608 indicates a boundary for where AI voice assistance device 606 will recognize voice commands if spoken at a whisper volume level. In another example, visual normal conversation loudness/distance boundary indicator 612 indicates a boundary for where AI voice assistance device 606 will recognize voice commands if spoken at a normal conversation volume level. Using sensors integrated into AR glasses 602, the user can control progress bar 604 with finger or eye based interaction. Progress bar 604 shows a wakeup duration indicative of remaining time left for AI voice assistance device 606 to remain in an “awakened” state after recognizing a vocalized wakeup command.

Some embodiments of the present invention may include one, or more, of the following operations, features, characteristics and/or advantages: (i) each and every device will be awakened individually and will create individual “wakeup duration” progress bars; (ii) in any surrounding, when multiple wakeup commands are submitted, then the head mounted AR glass will show individual “wakeup duration” progress bars; (iii) the user can perform interaction with “wakeup duration” progress bars selectively; (iv) using hand gestures or eye focus controls, the user can select any “wakeup duration” progress bar; (v) once any “wakeup duration” progress bar is selected, the user can expand the wakeup duration in the progress bar; (vi) at the same time, the user can apply pause, resume or stop functions to the “wakeup duration” progress bar; (vii) when the pause is applied to any “wakeup duration” progress bar, the device will not receive voice commands temporarily; (viii) upon resuming, voice commands will be accepted; (ix) using finger or eye based gestures, the user can pause and/or resume the “wakeup duration” progress bar; (x) the user can also use AR glass to visualize the loudness of voice command with the voice command receiving boundary; (xi) the AR glass will create and display a visual boundary diagram to show different level of loudness of voice with the boundary of submitting voice command; (xii) the user can perform finger gestures to alter the boundary; (xiii) in that case the loudness of voice command and distance from the voice assistance system can be altered; (xiv) historically the AI voice assistance system will learn how the user interacts with various “wakeup duration” progress bars, and will conduct self-learning to understand user's interaction pattern with different “wakeup duration” progress bars; and (xv) based on the matured knowledge corpus, the “wakeup duration” progress bar may be controlled dynamically.

Some embodiments of the present invention may include one, or more, of the following operations, features, characteristics and/or advantages: (i) enabling a user to visualize remaining time for a wakeup duration of an Artificial Intelligence (AI) voice assistance system using a head-mounted Augmented Reality (AR) glass; (ii) allowing the user to selectively control wakeup parameters such as, but not limited to, pausing, resuming or extending the wakeup duration while interacting with the AI voice assistance system; (iii) utilizing a head-mounted AR glass to enable the user to visualize a wakeup duration progress bar after the user submits any wakeup command to the AI voice assistance system; (iv) accordingly the user can understand the remaining time for the AI voice assistance system to remain awake for receiving and executing the voice command; (v) allowing the user to interact with the progress bar of wakeup duration of any AI voice assistance system via the head-mounted AR glass; (vi) enabling the user to increase the wakeup duration in the progress bar while interacting, and at the same time, the user is also enabled to pause, resume, or stop the wakeup of any AI voice assistance system in the wakeup duration; (vii) identifying if there are multiple voice assistance systems (such as TV, washing machine, etc.) apart from the AI voice assistance system; (viii) enabling each of the voice assistance devices to be awake based on the AI voice assistance systems' specific wakeup call and enabling the head-mounted AR glass to show the wakeup duration progress bar individually for each of the wakeup commands, if multiple wakeup commands are submitted to multiple voice assistance devices; (ix) enabling the head-mounted AR glass to show an overlap wakeup duration progress bar assigned to different users who have individually submitted a voice command, if multiple wakeup commands are submitted for a same AI voice assistance system or any voice enabled AI voice assistance device; and (x) accordingly enabling the users to selectively interact with the wakeup duration progress bar individually.

Some embodiments of the present invention may include one, or more, of the following operations, features, characteristics and/or advantages: (i) enabling the user to use hand, finger and/or eye gestures to control and interact with the wakeup duration progress bar; (ii) in any surrounding with multiple wakeup duration progress bars shown at the same point in time, selecting appropriate wakeup duration progress bars based on the user's eye focus distance; (iii) enabling the user to also visualize a physical boundary around any AI voice assistance device where the wakeup command will be activated based on any given loudness factor of a voice command using the head-mounted AR glass; (iv) enabling the user to visualize a level of loudness based wakeup boundary ranges of any AI voice assistance device; (v) the visual diagram helps the user to understand what will be the loudness of his voice command based on the distance from the AI voice assistance device; (vi) user can decide if the user can move closer to the AI voice assistance device to submit the voice command; (vii) enabling a machine learning model to understand the user's interaction with a wakeup duration progress bar in a different contextual situation, such as when the user is expanding the wakeup duration, when the user is pausing, resuming, etc.; (viii) accordingly the machine learning model performs auto-execution of wakeup duration progress bar based on the historical interaction with the wakeup duration progress bar; (ix) uses an AR approach to vary the command input time and vary the input lengths; (x) a way to visualize the wake word activation; (xi) a way to control pause the command in middle; (xii) this enables the user to have much better control in giving commands; (xiii) the user can also change the command wait window using AR interaction using visual action or gesture; (xiv) this eliminates the repeated wake word and enhances the user experience during device interactions; (xv) this is also adding VR (or AR) interaction to smart assistance for controlling the command length and enables gesture controls via VR (or AR) to smart assistance devices; (xv) a way to vary the input wait duration and is focusing on usability of the smart assistant devices; (xvi) controlling the user input wait time and avoiding repeated wake work for the smart device; (xvii) user command input window change via gestures and interaction; and (xviii) varying the user input wait duration via VR (or AR) environment and gestures.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

In an Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, and application-specific integrated circuit (ASIC) based devices.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

We: this document may use the word “we,” and this should be generally be understood, in most instances, as a pronoun style usage representing “machine logic of a computer system,” or the like; for example, “we processed the data” should be understood, unless context indicates otherwise, as “machine logic of a computer system processed the data”; unless context affirmatively indicates otherwise, “we,” as used herein, is typically not a reference to any specific human individuals or, indeed, any human individuals at all (but rather a computer system).

1. A computer-implemented method (CIM) for use with an augmented reality (AR) device, the CIM comprising:
pairing the AR device in data communication with an AI voice assistance device, with the AI voice assistance device being programmed to wake up from an idle state upon a predetermined utterance by a user and to remain in a wake state, receptive to further user voice command(s), for a predetermined amount of time before returning to the idle state in absence of receiving further user voice command(s) during the predetermined time period;
receiving, by the AI voice, an indication that a user has spoken the predetermined utterance;
responsive to the receipt of the indication that the user has spoken the predetermined utterance, configuring the AI voice assistance device to the wake state for the predetermined amount of time; and
further responsive to the receipt of the indication that the user has spoken the predetermined utterance, displaying, on a display of the AR device, a visual indication of an amount of time is left before the predetermined amount of time has fully elapsed.

2. (canceled)

3. The CIM of claim 1 wherein the AI voice assistance device includes a smart speaker.

4. The CIM of claim 1 where the predetermined utterance must exceed a threshold decibel level in order to wake up the AI assistance device.

5. The CIM of claim 1 wherein the visual indication is in the form of a progress bar that is adjusted so that the length of a bar corresponds to an amount of time remaining before the predetermined amount of time has fully lapsed.

6-18. (canceled)

19. A computer program product (CPP) for use with an augmented reality (AR) device, the CPP comprising:
a set of storage device(s); and
computer code stored collectively in the set of storage device(s), with the computer code including data and instructions to cause a processor(s) set to perform at least the following operations:
pairing the AR device in data communication with an AI voice assistance device, with the AI voice assistance device being programmed to wake up from an idle state upon a predetermined utterance by a user and to remain in a wake state, receptive to further user voice command(s), for a predetermined amount of time before returning to the idle state in absence of receiving further user voice command(s) during the predetermined time period,
receiving, by the AI voice, an indication that a user has spoken the predetermined utterance,
responsive to the receipt of the indication that the user has spoken the predetermined utterance, configuring the AI voice assistance device to the wake state for the predetermined amount of time, and
further responsive to the receipt of the indication that the user has spoken the predetermined utterance, displaying, on a display of the AR device, a visual indication of an amount of time is left before the predetermined amount of time has fully elapsed.

20. The CPP of claim 19 wherein the AI voice assistance device includes a smart speaker.

21. The CPP of claim 19 where the predetermined utterance must exceed a threshold decibel level in order to wake up the AI assistance device.

22. The CPP of claim 19 wherein the visual indication is in the form of a progress bar that is adjusted so that the length of a bar corresponds to an amount of time remaining before the predetermined amount of time has fully lapsed.

23. A computer system (CS) for use with an augmented reality (AR) device, the CS comprising:
a processor(s) set;
a set of storage device(s); and
computer code stored collectively in the set of storage device(s), with the computer code including data and instructions to cause the processor(s) set to perform at least the following operations:
pairing the AR device in data communication with an AI voice assistance device, with the AI voice assistance device being programmed to wake up from an idle state upon a predetermined utterance by a user and to remain in a wake state, receptive to further user voice command(s), for a predetermined amount of time before returning to the idle state in absence of receiving further user voice command(s) during the predetermined time period,
receiving, by the AI voice, an indication that a user has spoken the predetermined utterance,
responsive to the receipt of the indication that the user has spoken the predetermined utterance, configuring the AI voice assistance device to the wake state for the predetermined amount of time, and
further responsive to the receipt of the indication that the user has spoken the predetermined utterance, displaying, on a display of the AR device, a visual indication of an amount of time is left before the predetermined amount of time has fully elapsed.

24. The CS of claim 23 wherein the AI voice assistance device includes a smart speaker.

25. The CS of claim 23 where the predetermined utterance must exceed a threshold decibel level in order to wake up the AI assistance device.

26. The CS of claim 23 wherein the visual indication is in the form of a progress bar that is adjusted so that the length of a bar corresponds to an amount of time remaining before the predetermined amount of time has fully lapsed.
